(19) United States
(12) Patent Application Publication
(10) Pub. No.: US 2013/0086067 A1
(43) Pub. Date: Apr. 4, 2013

(54) CONTEXT-AWARE SUGGESTIONS FOR STRUCTURED QUERIES

(71) Applicant: University of Washington Through its Center for Co, Seattle, WA (US)

(72) Inventors: Nodira Khoussainova, Seattle, WA (US); Yongchul Kwon, Seattle, WA (US); Magdalena Balazinska, Seattle, WA (US); Dan Suciu, Seattle, WA (US)

(73) Assignee: University of Washington Through its Center for Commercialization, Seattle, WA (US)

(21) Appl. No.: 13/631,356

(22) Filed: Sep. 28, 2012

Related U.S. Application Data
(60) Provisional application No. 61/541,482, filed on Sep. 30, 2011.

(51) Int. Cl. G06F 17/30

(52) U.S. Cl. 707/737; 707/767; 707/E17.066; 707/E17.046

(57) ABSTRACT

A suggestion system for providing suggestions of features for inclusion in a clause of a structured query. The suggestion system receives a partial query that is being created by a user. The suggestion system analyzes a query log having queries submitted by one or more users to identify features to suggest to the user based on a likelihood that users who submitted queries similar to the partial query included that feature in the query. The query system then presents to the user the identified features as suggestions to include in the partial query.

### CROSS-REFERENCE TO RELATED APPLICATION(S)

This application claims the benefit of U.S. Provisional Patent Application No. 61/541,482 filed Sep. 30, 2011, which is incorporated herein by reference in its entirety.

### STATEMENT REGARDING FEDERALLY SPONSORED RESEARCH

This invention was made with government support under IIS-0845397, IIS-0713576, CNS-0454425, and IIS-0627585, each awarded by the National Science Foundation. The government has certain rights in the invention.

### BACKGROUND

Recent advances in technology, especially in data collecting and high-performance computing, are fundamentally changing how research is conducted in many fields of science. Many data collections store vast amounts of data that can only be effectively analyzed using a massively parallel data processing system. For example, the Sloan Digital Sky Survey (“SDSS”) has mapped 25% of the sky and collected over 30 TB of data (images and catalogs) on about 350 million celestial objects. SDSS has transformed astronomy research not only because its data is valuable, but also because the data has been made available to researchers via the Structured Query Language (“SQL”). Scientists have already submitted well over 20 million SQL queries to the SDSS database. There are many more examples of SQL use in science. For example, the SQLShare system, developed by the eScience institute at the University of Washington, allows scientists to upload their data (e.g., in EXCEL files) and immediately submit queries using SQL.

SQL employs a familiar select-from-where paradigm in which a SELECT clause specifies the data to be retrieved from a database, the FROM clause specifies the tables from which the data is to be retrieved, and the WHERE clause specifies predicates to restrict the data that is retrieved. The following is a sample query for the SDSS database.

SELECT *

FROM PhotoPrimary p, fGetNearbyObjEQ(145.622, 0.0346249, 2) n
WHERE p.objID = n.objID AND p.r < 18 and p.r > 15
ORDER BY p.r.

This query finds the stars with a brightness between 15 and 18 in the r-band that are within 2 arc minutes of the star with a right ascension of 145.622 and a declination of 0.0346249. The SELECT clause specifies to return all of the attributes from the tables. The FROM clause specifies that the attributes from the PhotoPrimary table and the table generated by the fGetNearbyObjectEQ user-defined function (“UDF”) should be selected. The WHERE clause specifies that the result is to include stars that are in both tables and that have the specified brightness. The ORDER BY clause specifies that the objects in the result are to be ordered by brightness. Each clause has a clause type (e.g., SELECT or FROM) and one or more features (e.g., PhotoPrimary and p.objID).

By using SQL to analyze large data sets, scientists are making important scientific advances. Unfortunately, creating SQL queries remains a challenge for many scientists. Although the scientists are highly trained professionals and can easily grasp the basic select-from-where paradigm of SQL, they need to use advanced query features, including group-bys, outer-joins, user-defined functions returning tables, or spatial database operators to conduct advanced research. In addition, the scientists have to cope with complex database schemas. For example the SDSS schema has 88 tables, 51 views, 204 user-defined functions, and 3,440 columns. The learning curve for becoming an expert SQL user on a specific scientific database is steep.

Many scientists today leverage database management systems (DBMSs) only with the help of computer scientists. Alternatively, they may compose their SQL queries by sharing and reusing sample queries. For example, the SDSS website provides a selection of 57 sample queries that correspond to popular questions posed by its users. Similarly, SQLShare provides a “starter kit” of SQL queries that are translated from English questions provided by scientists. Scientists can then create complex SQL queries by “copying and pasting” from the starter kit. A drawback to using sample SQL queries is that scientists either have access to only a small sample, which may not contain the information they need, or they must search through massive logs of past queries (if available), which can be overwhelming.

Although some automated tools have been developed to help users create SQL queries, these tools generally focus on assisting the novice user. For example, several visual query building tools provide assistance to novice users who struggle with simple SQL queries and the basic select-from-where paradigm. These tools are of little help to scientists who need to develop complex SQL queries. Some tools have been proposed to cluster and rank relations in a complex schema by their importance and then to recommend important tables and attributes to SQL users. Because scientists are experts in their fields, they can quickly learn the important tables and attributes. As a result, such recommendations are a little value to scientists. Scientists do not need help with the basic select-from-where paradigm, but with advanced features—the seldom-used tables and attributes, UDFs, complex domain-specific predicates, etc.

### BRIEF DESCRIPTION OF THE DRAWINGS

FIG. 1 is a block diagram that illustrates the processing of the segmentation phase and the stitching phase of the suggestion system in some embodiments.

FIG. 2 shows an example workload DAG for 30 queries.

FIG. 3 is a block diagram that illustrates components of the suggestion system in some embodiments.

FIG. 4 is a flow diagram that illustrates the processing of the get suggestions component of the suggestion system in some embodiments.

FIG. 5 is a flow diagram that illustrates the processing of the get popular features component of the suggestion system in some embodiments.

FIG. 6 is a flow diagram that illustrates the processing of the select similar queries component of the suggestion system in some embodiments.

FIG. 7 is a flow diagram that illustrates the processing of the select popular features component of the suggestion system in some embodiments.

FIG. 8 is a flow diagram that illustrates the processing of a select final queries component of the suggestion system in some embodiments.

FIG. 9 is a flow diagram that illustrates the processing of the identify segments component of the suggestion system in some embodiments.

FIG. 10 is a flow diagram that illustrates the processing of the stitch segments component of the suggestion system in some embodiments.

### DETAILED DESCRIPTION

A method and system that suggests features for inclusion in a clause of a partial query based on previously submitted queries that are similar to the partial query is provided. In some embodiments, a suggestion system receives an indication of a partial query and the selection of a clause within the partial query. For example, the partial query may be

SELECT p.objID, p.r

FROM PhotoPrimary p, fGetNearbyObjEQ(?, ?, ?) n
WHERE

with the WHERE clause being the selected clause. The suggestion system identifies features to suggest for inclusion in the selected clause based on an analysis of queries similar to the partial query. A query is similar to the partial query based on the features that the query has in common with the partial query. A feature is determined to be in common when both the query and the partial query have that feature in the same clause. For example, the following query has the p.objID attribute, the PhotoPrimary table, and the fGetNearbyObjEQ UDF as features in common with the partial query illustrated above. The queries, however, do not have the attribute p.r in common because the partial query has the p.r attribute in the SELECT clause and the following query has the p.r attribute in the ORDER BY clause.

SELECT p.objID

FROM PhotoPrimary p, fGetNearbyObjEQ(145.622, 0.0346249, 2) n
WHERE p.objID = n.objID AND p.r < 18 and p.r > 15
ORDER BY p.r.

The more features that a query has in common with a partial query the more similar the query is to the partial query. The suggestion system identifies the features of the similar queries that will be suggested based on the probability of that feature being in the selected clause of similar queries. For example, if 90 of the similar queries have the “p.objID=n.objID” predicate, then the suggestion system may recommend the “p.objID=n.objID” predicate before any other predicate with a count less than 90. The suggestion system thus suggests features that are likely to be relevant given the current context of a partial query (e.g., the features of the partial query) as well as queries previously submitted by users that include a similar context.

In some embodiments, to identify features that are relevant for a selected clause of a partial query, the suggestion system selects queries that are similar to the partial query and then selects popular features of those similar queries. The suggestion system identifies as similar queries those that have a feature in common with each feature of the partial query. For example, if the partial query has 10 features, then the suggestion system identifies a query as similar if it also has those 10 features. The suggestion system then identifies the popular features by counting the number of times each feature that is not already in the partial query is in a similar query. For example, if there are 100 queries that are similar to the following query and 90 of them include the “p.objID=n.objID” predicate and 20 of them include the “p.r<18 and p.r>15” predicate, then their counts would be 90 and 20, respectively. The suggestion system may represent “p.r<18” and “p.r>15” as separate features and remove the constants resulting in the features of “p.r<#” and “p.r>#.”

SELECT *

FROM PhotoPrimary p, fGetNearbyObjEQ(?, ?, ?) n
WHERE

As a partial query becomes more complex, the number of queries that have all of the features of the partial query decreases. To ensure that sufficient features are suggested, the query system may relax the definition of what is considered similar by reducing the number of features that a query needs to have in common with the partial query. For example, if the partial query has 10 features and not enough popular features can be identified from the queries that have all 10 of those features, then the suggestion system would identify popular features of queries that have 9 features in common and continues relaxing the definition until a sufficient number of popular features has been identified.

In some embodiments, the suggestion system may use various approaches to determine whether a feature is popular. As described above, the suggestion system may simply select those features that have been used the most in similar queries. One problem with such an approach is that if a query is extremely popular, the features with the highest counts will likely be part of that query. As a result, all of the popular features will lead the user to the same extremely popular query with little chance of providing suggestions that lead to other queries. To overcome this difficulty, the suggestion system may suggest features that will likely lead the user to different queries. As the suggestion system relaxes the definition of what is similar, the suggestion system excludes any query with at least one feature that has already been included as a popular feature. As a result, such popular queries will not have the other features counted, thus giving features in not so popular queries a better chance of being considered popular and then suggested to a user.

In some embodiments, the previously submitted queries may be recorded in a query log of a database system. Since a query log may contain millions of queries, the suggestion system pre-processes the queries so that suggested features can be identified in real-time as users create queries. A query log may contain, for each query, a user identifier for the user who submitted the query, a submission time, and the query text. The suggestion system generates auxiliary tables that include a queries table, a features table and a query/features table from the query log. The queries table contains, for each query, an entry that includes the user identifier, the submission time, and the query text. The features table contains, for each feature of the query log, one entry that includes the feature and the clause that the feature is within. For example, if the PhotoPrimary table feature appears in the WHERE clause of 10 million queries, the features table will include only one entry for that feature. The query/features table maps queries to features and has, for each feature of each query, an entry that includes an identifier of a query in the queries table and an identifier of a feature in the features table.

In some embodiments, the suggestion system pre-processes the query log to eliminate queries that are not the final query of a query session. A query session is a sequence of queries written by the same user as part of a single task that generates the final query for that task. The suggestion system identifies query sessions in two phases. In the first, or segmentation, phase the suggestion system analyzes any changes between consecutive queries that have been submitted by a user to identify the beginning of a new revision cycle. A revision cycle is the process by which a user refines and resubmits a query until a desired task is complete or another task has been started. The suggestion system labels the queries from the start of one revision cycle to the start of the next as a query segment. In the second, or stitching, phase the suggestion system stitches multiple query segments together if they are part of a single, larger revision cycle. For example, when a user is having problems formulating a complex query, the user may switch to formulate a different query and later return to the complex query. The formulation of the complex query is thus separated into two query segments by the formulation of the intervening different query. The suggestion system identifies that the two query segments for the complex query represent the same query session and stitches the query segments together to form a single query session.

In some embodiments, the suggestion system may use a supervised learning algorithm to identify both the beginning of a revision cycle and which revision cycles should be stitched together to be part of the same query session. The segmentation phase employs a classifier that is trained using various segmentation features derived from pairs of time-wise adjacent queries. These segmentation features may include the time intervals between queries, a cosine similarity between the clauses that are not the same, and any relationships between abstract syntax tree (“AST”) representations of the queries. One relationship between ASTs, referred to as inclusion type, can indicate whether the queries are the same, the second query has more terms than the first query, the second query has fewer terms than the first query, the first query is a subquery of the second query, the second query is a subquery of the first query, or some other type of relationship. To train the classifier, the suggestion system extracts the segmentation features for pairs of features from a query log of training data. The pairs may be manually labeled to indicate whether they are in the same or different segments. The stitching phase may employ a classifier that is trained using the same segmentation features (except for the time interval feature) and the same labeling as that employed by the segmentation phase. The stitching phase compares the last query in each segment to the first query in each time-wise successor segment to determine whether the queries are in the same segment.

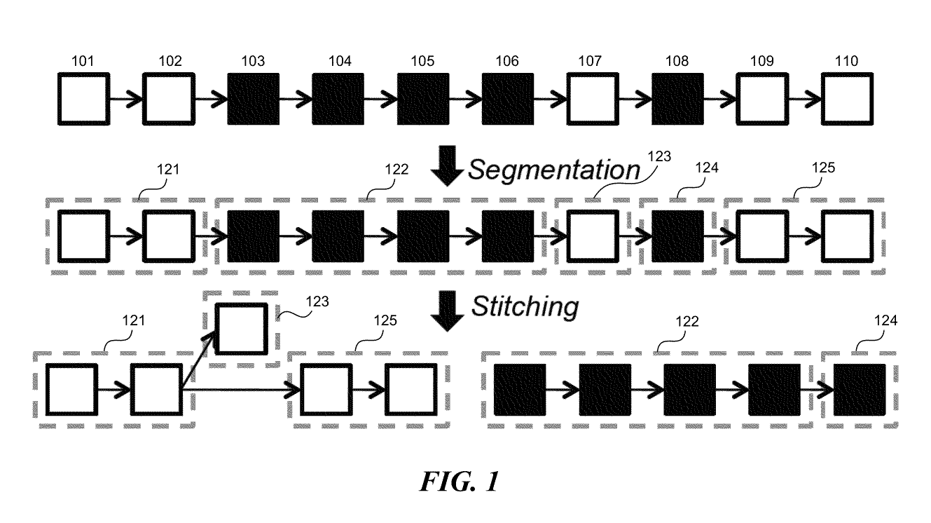

FIG. 1 is a block diagram that illustrates the processing of the segmentation phase and the stitching phase of the suggestion system in some embodiments. The query log contains queries 101-110, which are represented by shaded and unshaded squares. The shaded squares belong to one query session and the unshaded squares belong to another. The segmentation phase identifies segment 121 with queries 101 and 102, segment 122 with queries 103-106, segment 123 with query 107, segment 124 with query 108, and segment 125 with queries 109 and 110. The stitching phase links segment 121 with segments 123 and 125 and links segment 122 to segment 124.

In some embodiments, the suggestion system is a middleware-layer on top of a standard relational DBMS. When users submit queries against the database, a query logger component logs these queries in a query repository. The suggestion system uses this query repository to produce SQL-autocomplete recommendations. A query eliminator component periodically prunes the query log to improve recommendation performance by shrinking the query repository.

When the query logger component logs a query, it extracts various features from the query and updates the query repository. A feature is a specific fragment of SQL such as a table name in the FROM clause (or view name or table-valued function name) or a predicate in the WHERE clause.

The query repository comprises three tables: Queries, Features, and QueryFeatures. A Queries table contains metadata about the query (e.g., id, timestamp, query text) and may be populated using an existing infrastructure for query logging such as those offered by most DBMSs. A Features table lists each feature (i.e., SQL fragment) and the clause from which it was extracted. A QueryFeatures table lists which features appear in which queries. The query repository contains the following three tables:

1. Queries (id, timestamp, user, database name, query text, running time, output size)

2. Features (id, feature description, clause)

3. QueryFeatures (query, feature)

The Queries table stores the details of each logged query and may be populated by a DBMS existing infrastructure. The Features table consists of the features (i.e., SQL fragment) that have been extracted from these queries and the clauses from which they were extracted. The feature descriptions may be parameterized if there is some constant involved (e.g., the predicate PhotoPrimary.objID=55 is translated into the parameterized predicate PhotoPrimary.objID=#). The QueryFeatures table maintains the information about which features appears in which queries. The query repository may also contain the following tables:

1. MarginalProbs(featureID, probability)

2. CondProbs(feature1, feature2, probability)

The MarginalProbs table stores the marginal probability for each feature across the whole workload. The CondProbs table contains the conditional probability of feature1 given feature2, for every pair of features that have appeared together.

In some embodiments, the suggestion system supports the following classes of features:
1. F_{T}^{from} for every table, view and table-valued function T in the database, representing whether T appears in the FROM clause of the query.
2. F_{C}^{select}, F_{C}^{where}, and F_{C}^{groupby}, for every column C in the database, representing whether this column appears in the SELECT, WHERE, or GROUP BY clause of the query, respectively.
3. F_{aggr(C}_{₁}_{, . . . , C}_{ᵤ}₎^{select}, for every aggregate function and list of columns, representing whether this aggregate and list of columns appear in the SELECT clause.
4. F_{C}_{₁}_{op C}_{₂}^{where} for every pair of columns C₁, C₂, and every operator that appears in the database, representing whether this predicate appears in the WHERE clause of the query.
5. F_{C op}^{where} for every column C in the database, and for every operator, representing whether there is a predicate of the form C op constant in the WHERE clause of the query.
6. F_{ALL}^{subquery}, F_{ANY}^{subquery}, F_{SOME}^{subquery}, F_{IN}^{subquery}, and F_{EXISTS}^{subquery} whether there is a subquery in the WHERE clause, of the form ALL(subquery), ANY(subquery), SOME(subquery), IN(subquery), EXISTS(subquery), respectively.

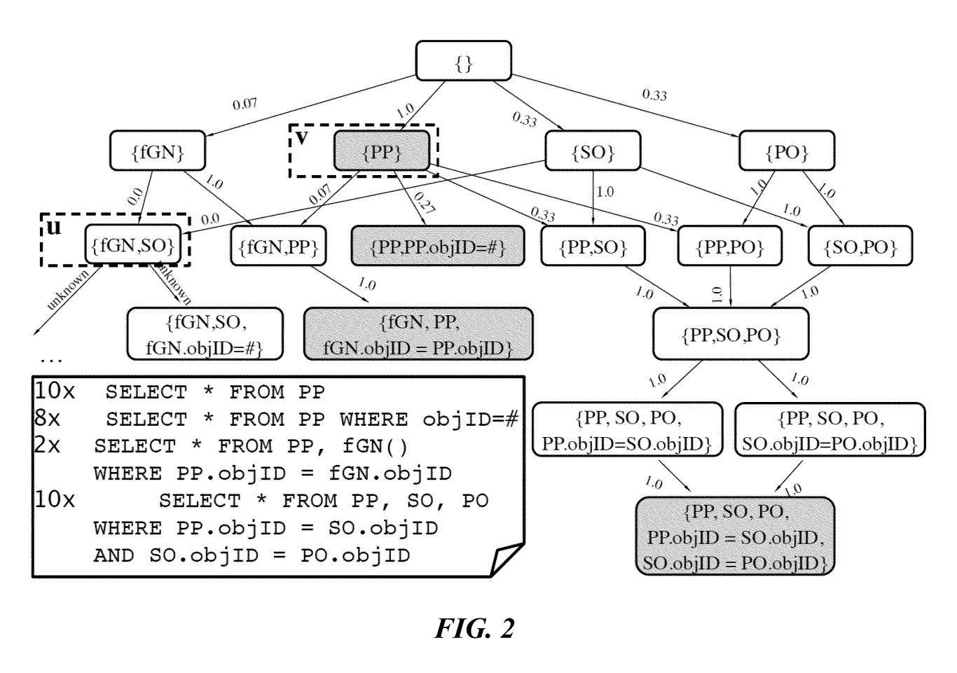

When a user composes a query, the user selects a clause and asks for recommendations with this clause. The goal of the suggestion system is to recommend k features that are most likely to appear in that clause in the user's intended query. To produce its recommendations, the suggestion system views the space of queries as a directed acyclic graph (“DAG”) such as that shown in FIG. 2. The suggestion system models each query as a set of features and every possible set of features becomes a vertex in the DAG. When a user asks for a recommendation, the suggestion system transforms the user's partially written query into a set of features, which it maps onto a node in the DAG. Each edge in the DAG represents the addition of a feature (i.e., it links together sets of features that differ by only one element). The recommendation problem translates to that of ranking the outgoing edges for the vertex that corresponds to the user's partially written query, since this corresponds to ranking the addition of different features.

The query that the user intends to write is somewhere below the current vertex in the DAG, but the suggestion system does not know which query it is. It approximates the intended query with the set of all queries in the query repository that are descendants of the current vertex in the DAG. Such queries are referred to as the potential goals for the partial query. The suggestion system may assume that the set is not empty. Given this set of potential goals, there are several ways to rank the features that could possibly be added to the user query. One way is to recommend the most popular features among all those queries. A problem that arises is that this can result in k recommendations that all lead to a single, extremely popular query. An alternate method is to recommend k features that cover a maximum number of queries in the potential goals set.

The problem of selecting features for recommendation and some solutions are more formally described below.

DEFINITION 1. A feature f is a function that takes a query as input and returns true or false depending on whether a certain property holds on that query. Some examples are f_{PhotoPrimary}^{FROM} that represents whether the PhotoPrimary table appears in the query's FROM clause, f_{PhotoPrimary.objID=Neighbors.objID}^{FROM} that represent whether the predicate PhotoPrimary.objID=Neighbors.objID appears in the WHERE clause, or f_{distinct} that represents whether the keyword “distinct” appears anywhere in the query. A feature can also have a clause associated with it, denoted clause (f). For example, clause(f_{PhotoPrimary}^{FROM})=FROM. The notation fₛ^{c} denotes the feature that string s appears in clause c.

DEFINITION 2. The feature set of a query q, is defined as:

features(q)={f|f(q)=true}

When the suggestion system recommends a snippet or feature, it is recommending that the user modify the query so that the snippet evaluates as true for the query. For example, when it recommends f_{PhotoPrimary}^{FROM}, it is recommending that the user add PhotoPrimary to the FROM clause.

DEFINITION 3. The dependencies of a feature f, dependencies (f), is the set of features that must be in the query so that no syntactic error is raised when one adds f (e.g., dependencies (f_{PhotoPrimary.objID=Neighbors.objID}^{WHERE})={f_{PhotoPrimary}^{FROM}, f_{Neighbors}^{FROM}}). The suggestion system only suggests a feature f for a partial query q if dependencies(f)⊂features(q). In the DAG, feature sets have parent-child relationships defined as follows:

DEFINITION 4. A feature set F₂ is a successor of a feature set F₁, if ∃ f where F₂=F₁∪{f} and dependencies (f)⊂F₁.

A successor of a feature set F₁ is thus a feature set F₂ that can be reached by adding a single, valid feature. Additionally, recommendations are based on feature popularity that is captured by either marginal or conditional probabilities.

DEFINITION 5. Within a workload W, the marginal probability of a set of features F is defined as

$$P ( F ) = \frac{\vert \{ q ∈ W \vert F ⊆ features ( q ) \} \vert}{\vert W \vert}$$

(i.e., the fraction of queries which are supersets of F). As shorthand, P(Q) represents P(features(Q)), and P(f) represents P({f}).

DEFINITION 6. The conditional probability of a feature f given a feature set F is defined as

$$P ( f \vert F ) = \frac{P ( \{ f \} ⋃ F )}{P ( F )}$$

DEFINITION 7. The workload DAG T=(V,E,ω,χ) for a query workload W is constructed as follows:
1. Add to V, a vertex for every syntactically valid subset of F. Each vertex is referred to by the subset that it represents.
2. Add an edge (F₁, F₂) to E, if F₂ is a successor of F₁. Denote the additional feature of F₂ by addlFeature ((F₁, F₂))=f, where F₂=F₁∪{f}.
3. ω: E→[0,1] is the weight of each edge. The weights are set as: ω((X,Y))=P(addlFeature((X,Y))|X). If P(X)=0, then set to unknown.
4. χ: V→{shaded, unshaded} is the shading of each vertex. The shading set as: χ(q)=shaded if qεW, otherwise unshaded.
   where F is the set of all features (including those that do not appear in workload).

FIG. 2 shows an example workload DAG for 30 queries. The queries correspond to the shaded nodes and are summarized at the bottom. Ten queries are of the form SELECT*FROM PhotoPrimary, eight queries are of the form SELECT*FROM PhotoPrimary WHERE objID=#, etc. For simplicity, features in the SELECT clause and nodes that are not reachable from the root along edges of weight that are greater than 0, with the exception of node u, are excluded from the figure. The acronyms fGN, PP, SO, and PO represent f_{GetNearbyObjEq}^{FROM}, f_{PhotoPrimary}^{FROM}, f_{SpecObjAll}^{FROM}, and f_{PhotoObjAll}^{FROM}, respectively. The edge ({PP}, {PP,SO}) indicates that if a query contains PhotoPrimary, there is 33% chance that it also contains SpecObjAll.

Every syntactically correct partial query appears in the workload DAG since there is a vertex for every valid subset of F. Given a partial query and its vertex q, the goal of the suggestion system is to lead the user toward his or her intended query q* (also a vertex in the DAG), one snippet or feature at a time. The suggestion system assumes that there is a path from q to q* that is the user can reach q* by adding snippets to their query. Since the suggestion system suggests one snippet at a time, the recommendation problem becomes that of ranking the outgoing edges of q. Recommending an edge e corresponds to recommending addlFeature(e). In one example a user has written SELECT*FROM PhotoPrimary. This query is positioned at vertex v in FIG. 2. Then, the user requests features to add to the FROM clause. At v, the possible features include fGetNearbyObjEq( ) SpecObjAll, or PhotoObjAll. FIG. 2 is not showing the whole DAG. The full workload DAG contains an outgoing edge from v for each of the 343 tables, views, and table-valued functions in the SDSS schema. The suggestion system recommends the edges that are most likely to lead the user toward the intended query.

The suggestion system recommends suggestions based on the current context (i.e., the current partial query). In the following example, a definition of the problem that is to be solved is provided.

DEFINITION 8. Given a workload DAG and a vertex q, define potential_goals (q)={v|v is shaded and reachable from q}.

The potential_goals of q is the set of queries that could potentially be the user's intended query, if it appears in the workload. Sometimes, potential_goals (q) is the empty set.

Given a workload DAG G and a partial query q, the goal of two embodiments is to recommend a set of k outgoing edges, e₁, . . . , eₖ, from q that:

1. Max-Accuracy Problem: maximizes

$${\sum }_{i = 1}^{k} P ( addlFeature ( {e}_{i} ) \vert q )$$

2. Max-Query-Coverage Problem: maximizes
P(addlFeature(e₁) [symbol] . . . [symbol] addlFeature(eₖ)|q)
   Max-Accuracy aims to maximize the number of features in the top k that are helpful (i.e., appear in the intended query), whereas Max-Query-Coverage aims to maximize the probability that at least one feature in the top k is helpful.

Continuing with the example, assume the suggestion system recommends the top 2 snippets to add to the FROM clause. If the goal is Max-Accuracy, then it suggests SO and PO. This corresponds to the two outgoing edges from q, with the highest conditional probabilities. If the goal is Max-Query-Coverage, then it suggests SO and fGN. If the user's intention is the rightmost shaded query, then suggesting SO covers this case. If the user's intention is not that query, then rather than PO, it is better to suggest fGN because it increases the number of potential_goals covered.

In general, it is infeasible to build the workload DAG as it can have up to 2ⁿ vertices, where n=|F|. Thus, the suggestion system implements two algorithms that simulate traversing parts of the DAG without ever constructing it: SSAccuracy and SSCoverage.

Given a partial query q and a query workload W, the goal of the SSAccuracy algorithm is to suggest the k features with the highest conditional probabilities given q. If q's features have previously appeared together in past queries, SSAccuracy is able to efficiently identify the features with the highest conditional probabilities with a single SQL query over the QueryFeatures table, as shown in Table 1. The SQL query in Table 1 finds the most popular features among queries that share m features with partial query q. The NOT EXISTS clause is included for SSCoverage, but omitted for SSAccuracy.

TABLE 1

WITH SimilarQueries (query) AS --finds potential_goals
(SELECT query

FROM QueryFeature
WHERE feature IN features(q)

[AND NOT EXISTS ( --used only by SSCoverage

select * from QueryFeature q
where q.query=query and q.feature in (previous) ) ]

GROUP BY query
HAVING count(feature) = m)

SELECT qf.feature --popular features among SimilarQueries
FROM QueryFeature qf, SimilarQueries s
WHERE qf.query = s.query AND qf.feature NOT IN
features(q)
GROUP BY qf.feature
ORDER BY count (s.query) DESC

By setting m to |features(q)|, the first half of the query finds potential_goals(q), that is the queries that have all the features of q. It then orders all the features that appear in these SimilarQueries by their frequencies within this set of queries. Each qf.feature f corresponds to one outgoing edge from q (i.e., the edge e where addlFeature(e)=f). Additionally, if count(s.query) is divided by |potential_goals(q)|, the result would be P(f|q). Thus, this query returns a list of edges, ordered by weight (i.e., the conditional probability of the feature given q).

Every partial query q appears in the DAG, but it can happen that all incoming edges have weight 0, and all outgoing edges are unknown. This happens when potential_goals(q)=. This occurs, for example, if the user has written q=SELECT FROM SpecObjAll, fGetNearbyObjEq(143.6,0.021,3) and requests suggestions in the FROM clause (which is represented by vertex u in FIG. 2).

The suggestion system traverses up the DAG from q until it reaches the vertices whose marginal probability is not zero (i.e., there exists an incoming edge with weight>0). This allows the system to find the largest subsets of features(q) that appear in the workload. In the above example, the suggestion system traverses up to the vertices {SO} and {fGN}. The suggestion system suggests the most popular features among the queries under these vertices. This can be achieved by executing the SQL query shown in Table 1. First, the suggestion system sets m to |features(q)|, thus looking at potential_goals (q). If fewer than k features are returned, it sets m to |features(q)|−1, thus considering queries that share |features(q)|−1 features with q. It repeatedly decrements m until k features are returned. The suggestion system executes the query in Table 1 at most |features(q)| times. In other words, the suggestion system will not iterate through every subset of features(q). Instead, it considers all subsets of size m all at once, and it does this for m=n, n−1, n−2, . . . , 0, where n=|features(q)|.

This process can cause some ambiguity as to how to rank features. For example, if P(f₁|{SO,fGN})=0.8 and P(f₂|{SO})=0.9, it is not clear whether f₁ or f₂ should be ranked first. Heuristically, the suggestion system picks f₁, because it ranks recommendations based on more similar queries first. Algorithm 1 outlines the full SSAccuracy algorithm (if passed t=SSAcc).

Algorithm 1

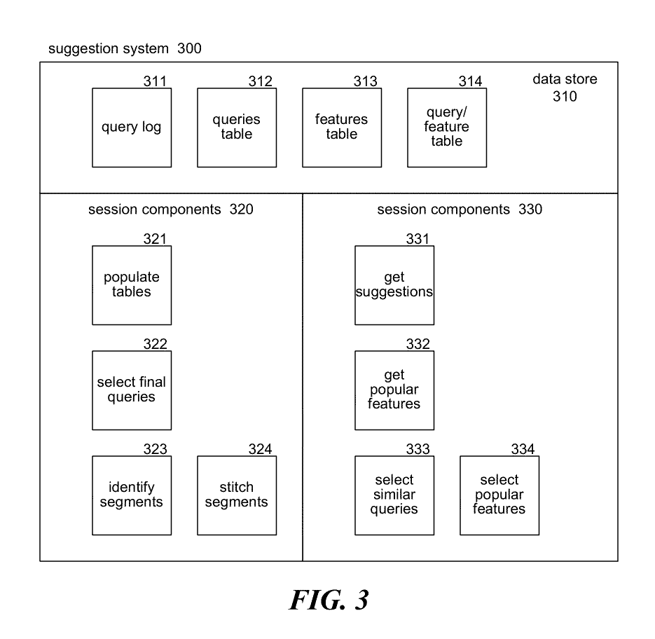

Input: query q , number of suggestions k , clause c , technique t
Output: a ranked list of snippet features

| | |
|---|---|
| 1: | i ← \| features ( q )\| |
| 2: | suggestions ← [ ] |
| 3: | while \| suggestions\| < k : do |

| | |
|---|---|
| 4: | if t = SSAcc then |

| | |
|---|---|
| 5: | S ← execute Figure 3 query ( m ← i , exclude NOT |
| | EXISTS clause) |

| | |
|---|---|
| 6: | else if t = SSCov then |

| | |
|---|---|
| 7: | S ← execute Figure 3 query ( m ← i , previous ← |
| | suggestions ) |

| | |
|---|---|
| 8: | end if |
| 9: | for all s ∈ S do |

| | |
|---|---|
| 10: | if s ∉ suggestions and clause( s ) = c then |

| | |
|---|---|
| 11: | suggestions ← suggestions, s |

| | |
|---|---|
| 12: | end if |

| | |
|---|---|
| 13: | end for |
| 14: | i ← i − 1 |

| | |
|---|---|
| 15: | end while |
| 16: | return suggestions |

In some embodiments, the suggestion system uses two relations to improve the SSAccuracy algorithm's recommendation time. The first is MarginalProbs, which contains P(f) for every feature f. When the user's partial query q is the empty query (i.e., features(q)=0), or if q consists of only features that have never before appeared in the workload, the suggestion system executes an order by query over MarginalProbs, instead of the more complex SQL in Table 1. (When q contains only unseen features, the suggestion system traverses up to the root vertex since it is the largest subset of q that appears in the workload. So, the suggestion system makes its suggestions for 0, and thus exploits MarginalProbs.)

The second is CondProbs, which contains the conditional probability P(f₁|f₂) for every pair of features f₁, f₂. It is indexed on the f₂ column. It is leveraged when the user's partial query q contains just one feature f, or it contains multiple features, but only one feature f has appeared in the workload. In these cases, the suggestion system can execute a simple query over CondProbs with filter f₂=f, and order by the conditional probability, instead of executing the slower SQL in Table 1.

The Max-Query-Coverage problem suggests the features f₁, . . . , fₖ that maximize the probability of at least one suggestion being helpful. The goal is to diversify the suggestions, in order to avoid making suggestions that all lead toward the same query. It turns out that the problem is NP-hard. Instead of an exact solution, in some embodiments, the suggestion system uses an approximation algorithm, SSCoverage, which is a greedy, approximation algorithm for Max-Query-Coverage. Given a set of elements U and a set of sets S=S₁, . . . , Sₙ, where each SᵢεU, the Maximum Coverage problem is to find a subset of S of size k (fixed) such that a maximum number of elements in U are “covered.”

The SSCoverage algorithm proceeds as follows. To compute the first recommendation f₁, it executes the SQL query in Table 1, with the NOT EXISTS clause and previous ←. This is equivalent to SSAccuracy's first recommendation because the Max-Accuracy and Max-Query-Coverage formulas are equivalent when k=1. For its second suggestion, SSCoverage executes the Table 1 query again, but with previous ←{f₁}. This effectively removes all the queries covered by f₁ (i.e., potential_goals(q∪{f₁})), and finds the feature with the highest coverage (i.e., conditional probability) in the remaining set. In terms of the workload DAG, this step discards the whole subgraph rooted at f₁, and then finds the best feature among the remaining DAG. It repeats this process k times in order to collect k features. Algorithm 1 describes SSCoverage in detail (if passed t=SSCov).

As discussed above, the suggestion system extracts query sessions from the query log and then eliminates all queries except those that appear at the end of a session. The goal of the segmentation phase is to take a pair of consecutive queries P, Q, and decide whether the two queries belong to the same query session or not. The algorithm proceeds in three steps. First, it constructs the AST for each query and transforms it into canonical form, by, for example, removing any constants, and alphabetically ordering the list of tables in the FROM clause (this process is also used by the query logger component). Second, it extracts a set of segmentation features from P and Q as well as extra information such as timestamps of queries and the query output of the preceding query P. Unlike the features used for recommendations, the segmentation features capture the differences between two queries. Some examples include the time interval between the queries, the cosine similarities between their different clauses, and the relationship between ASTs. In the third step, using these segmentation features, the suggestion system may use a perception-based classification algorithm to decide whether the queries belong in the same segment. For this final step, as training data, the suggestion system requires some labeled data in the form of queries labeled with the identifier associated with the task that the queries are intended for.

A significant segmentation feature is AST inclusion type. This feature represents whether the relationship between the two queries' ASTs is the Same, Add, Delete, Merge, Extract or None. This feature is based on the following observations. Within a query segment, a user incrementally adds or removes terms from the query after seeing the query result of the previous query. Such incremental edits are captured by the values Same, Add, or Delete. Occasionally, the user may introduce a subquery written in the past or copied from some sample query to compose a more complex query. The user may also pull out a subquery to debug or analyze unexpected results. In both these cases, the user may start to work toward a different purpose when the change involves subqueries; this signals a new query segment. Merge and Extract captures such changes that involve subqueries. Table 2 summarizes these five AST inclusion types. Each feature value in Table 2 has an expected decision on segmentation that is discussed in the text. P and Q denote the preceding query and the following query, respectively.

Although the AST inclusion type may be a strong indicator of continuing or breaking a query segment, it does not capture the amount of change. Thus, the other segmentation features, which capture the degree of change, help improve accuracy.

| Label | Description | Expect a new segment? |
|---|---|---|
| Same | Q is canonically the same as P | No |
| Add | Q is based on P and has more terms | No |
| Delete | Q is based on P and has fewer terms | No |
| Merge | P is a subquery of Q | Yes |
| Extract | Q is a subquery of P | Yes |
| None | All other types of changes | Unknown |

Query segments are useful because of the coherency among the queries in the same segment. However, in order to extract more complete query sessions, the suggestion system stitches together multiple segments.

The stitching phase tests whether two segments create a single revision cycle, smooth transitions with small changes, when they are concatenated in time order. To perform stitching, the suggestion system iterates over each segment s in the input and all its time-wise successor segments. It runs the core of the segmentation algorithm between the last query of s and the first query of a time-wise successor segment t with a modification. Since the suggestion system is now considering segments that are separated by multiple segments, the time interval between the queries becomes less meaningful. Thus, the algorithm treats the time interval as a missing attribute. Then, if the segmentation algorithm outputs that the last query of s and the first query of t belong in the same segment and this does not contradict the value of AST inclusion type, the suggestion system concatenates the two segments.

FIG. 3 is a block diagram that illustrates components of the suggestion system in some embodiments. The suggestion system includes a data store (e.g., query repository) 310, session components 320, and suggestion components 330. The data store includes a query log 311, a queries table 312, a features table 313, and a query/feature table 314. The session components include a populate tables component 321, a select final queries component 322, an identify segments component 323, and a stitch segments component 324. The select final queries component invokes the identify segments component and the stitch segments component to identify query segments of the query log and select the final query of each query segment. The populate tables component populates the queries table, the features table, and the query/feature table based on final queries. The suggestion components include a get suggestions component 331, a get popular features component 332, a select similar queries component 333, and a select popular features component 334. The get suggestions component repeatedly invokes the get popular features component relaxing the definition of similar queries until a sufficient number of popular features has been identified. The get popular features component invokes the select similar queries component to select the queries that are similar to a partial query and then invokes the select popular features component to identify the popular features of those similar queries.

The processor on which the suggestion system may be implemented may include a central processing unit and local memory and may include input devices (e.g., keyboard and pointing devices), output devices (e.g., display devices), and storage devices (e.g., disk drives). The processors may access computer-readable media that includes computer-readable storage media and data transmission media. The computer-readable storage media includes memory and other storage devices that may have recorded upon or may be encoded with computer-executable instructions or logic that implements the suggestion system. The data transmission media is media for transmitting data using signals or carrier waves (e.g., electromagnetism) via a wire or wireless connection. Various functions of the suggestion system may also be implemented on devices using discrete logic or logic embedded as an application-specific integrated circuit. The devices on which the suggestion system is implemented are computing devices.

The suggestion system may be described in the general context of computer-executable instructions, such as program modules, executed by one or more computers, processors, or other devices. Generally, program modules include routines, programs, objects, components, data structures, and so on, that perform particular tasks or implement particular data types. Typically, the functionality of the program modules may be combined or distributed as desired in various embodiments.

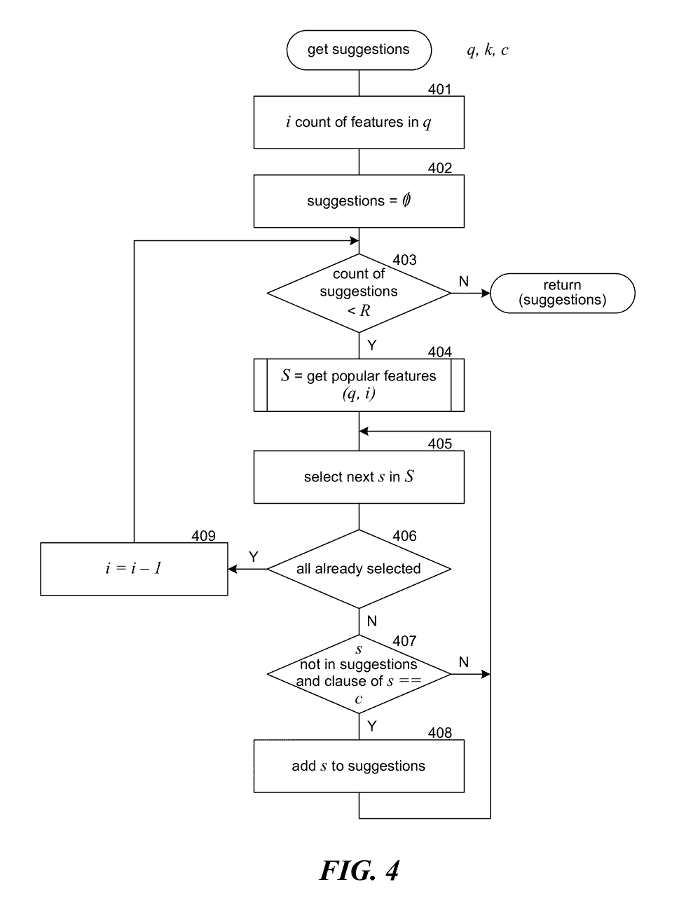

FIG. 4 is a flow diagram that illustrates the processing of the get suggestions component of the suggestion system in some embodiments. The component is passed an indication of a partial query (q), a selected clause (c), and a desired number of suggestions (k) to return. In block 401, the component initializes a variable (i), defining the number of features to be in common with the partial query for similar queries as number of features that are in the partial query. In block 402, the component sets the set of suggestions to be empty. In blocks 403-409, the component loops, identifying popular features and relaxing the definition of similar queries until a sufficient number of popular features has been identified. In decision block 403, if the number of suggestions is less than the desired number, then the component continues at block 404, else the component returns the suggestions. In block 404, the component invokes the get popular features component, passing it an indication of the partial query and the variable defining similar queries and receives the popular features (S) in return. In blocks 405-408, the component loops adding popular features within the same clause as the selected clause to the set of suggestions. In block 405, the component selects the next popular feature. In decision block 406, if all the popular features have already been selected, then the component continues at block 409, else the component continues at block 407. In decision block 407, if the selected popular feature is not already in the set of suggestions and its clause matches the selected clause, then the component continues at block 408, else the component loops to block 405 to select the next popular feature. In block 408, the component adds the selected popular feature to the set of suggestions and loops to block 405 to select the next popular feature. In block 409, the component decrements the variable defining similar queries to relax the definition of similarity and loops to block 403 to see if a sufficient number of popular features has been added as suggestions.

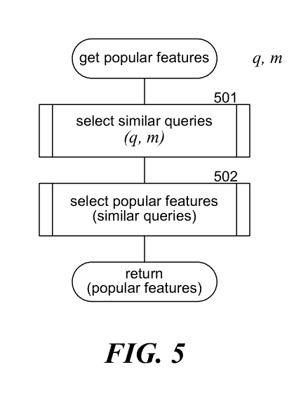

FIG. 5 is a flow diagram that illustrates the processing of the get popular features component of the suggestion system in some embodiments. The component is passed an indication of a partial query and a variable defining similar queries and returns popular features for the similar queries. In block 501, the component invokes the select similar queries component by passing it an indication of the partial query and the variable defining similar queries and receives the similar queries in return. In block 502, the component invokes the select popular features component by passing it the similar queries and receiving the popular features for the similar queries in return. The component then returns the popular features.

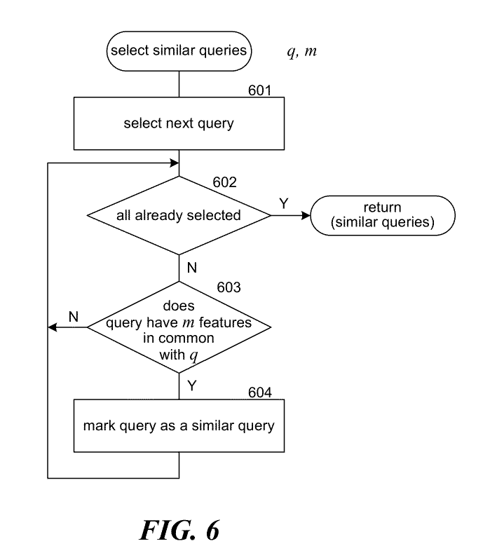

FIG. 6 is a flow diagram that illustrates the processing of the select similar queries component of the suggestion system in some embodiments. The component is passed an indication of a partial query and the variable defining similar queries and returns an indication of queries that are similar to the partial query. In block 601, the component selects the next query from the queries table. In decision block 602, if all the queries have already been selected, then the component returns the similar queries, else the component continues at block 603. In decision block 603, if the selected query has the same number of features in common with the partial query as the variable defining the similar queries, then the component continues at block 604, else the component loops to block 601 to select the next query. In block 604, the component marks the selected query as being a similar query and loops to block 601 to select the next query.

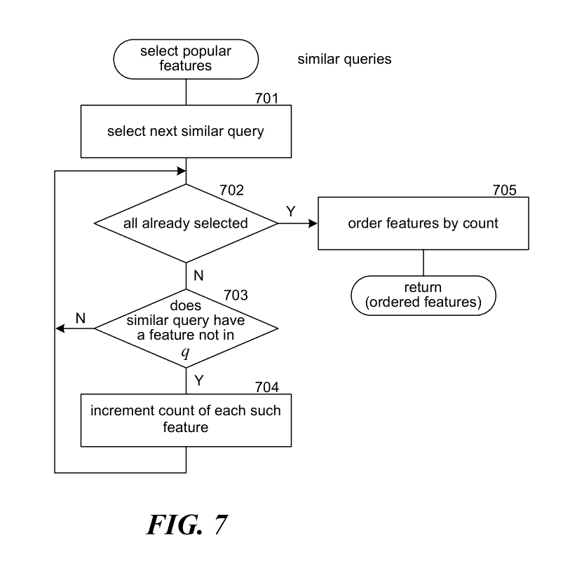

FIG. 7 is a flow diagram that illustrates the processing of the select popular features component of the suggestion system in some embodiments. The component is passed an indication of similar queries and returns the popular features of those similar queries ordered based on the number of queries that contain each popular feature. In block 701, the component selects the next similar query. In decision block 702, if all of the similar queries have already been selected, then the component continues at block 705, else the component continues at block 703. In decision block 703, if the selected similar query has a feature that is not in the partial query, then the component continues at block 704, else the component loops to block 701 to select the next similar query. In block 704, the component increments the count of each such feature of the selected similar query and then loops to block 701 to select the next similar query. In block 705, the component orders the features by their count and returns the ordered features.

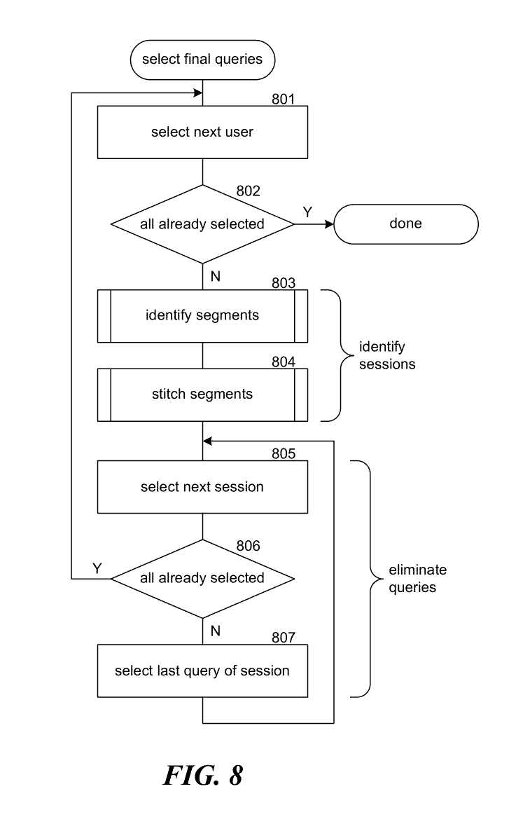

FIG. 8 is a flow diagram that illustrates the processing of a select final queries component of the suggestion system in some embodiments. The component identifies query segments within a query log, stitches the segments into sessions, and eliminates all queries other than the final query of each session. In block 801, the component selects the next user who submitted a query. In decision block 802, if all the users have already been selected, then the component completes with the selected queries representing the final queries of the query sessions, else the component continues at block 803. In block 803, the component invokes the identify segments component to identify query segments for the selected user. In block 804, the component invokes the stitch segments component to stitch together the identify query segments to form query sessions. Blocks 803 and 804 serve to identify the query sessions. In blocks 805-807, the component loops, eliminating all but the last query of each query session. In block 805, the component selects the next query session. In decision block 806, if all the query sessions have already been selected, then the component loops to block 801 to select the next user, else the component continues at block 807. In block 807, the component selects the last query of the selected query session and then loops to block 805 to select the next query session.

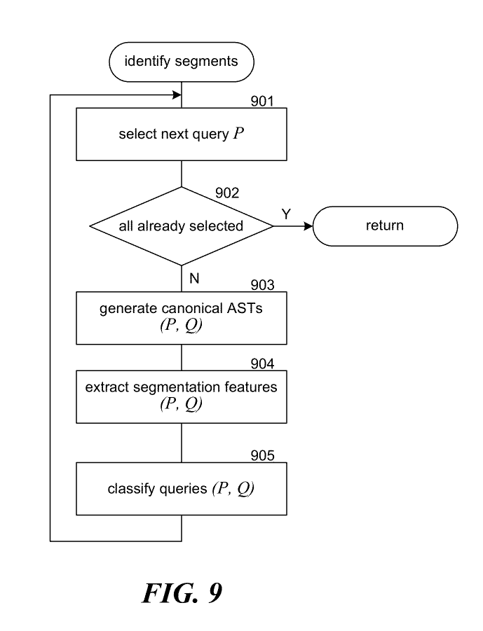

FIG. 9 is a flow diagram that illustrates the processing of the identify segments component of the suggestion system in some embodiments. The component loops, classifying each pair of time-wise adjacent queries of a user as being in the same or different segments employing a classifier that may have been trained using a supervised learning technique. In block 901, the component selects the next query (P) of the user. In decision block 903, if all the queries of the user have already been selected, then the component returns, else the component continues at block 903. In block 903, the component generates a canonical abstract syntax tree for the next query and the following query (Q). In block 904, the component extracts segmentation features for the selected pair of queries. In block 905, the component employs a classifier to classify the pair of queries as being in the same or different segments and loops to block 901 to select the next query of the user.

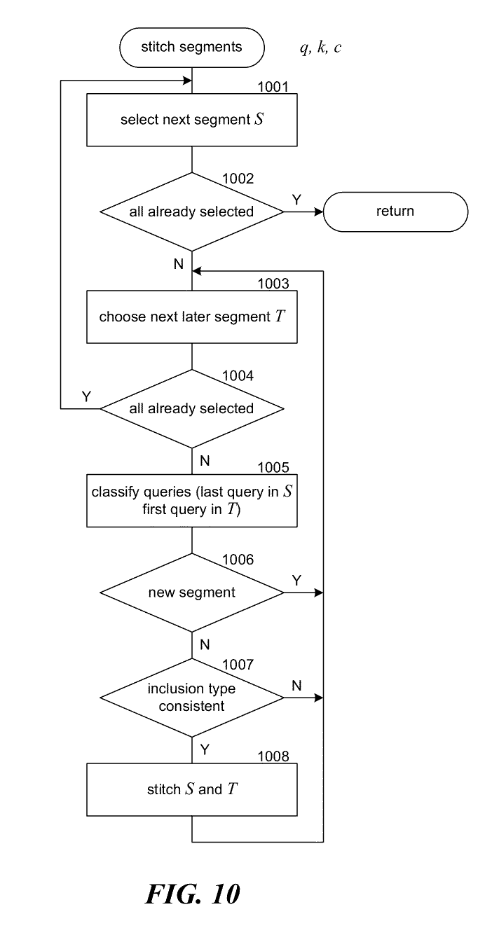

FIG. 10 is a flow diagram that illustrates the processing of the stitch segments component of the suggestion system in some embodiments. The component compares the last query of each segment of the user to the first query of each subsequent segment of the user to identify segments that are part of the same query session. In block 1001, the component selects the next query segment (S). In decision block 1002, if all the segments have already been selected, then the component returns, else the component continues at block 1003. In block 1003, the component chooses the next later query segment (T). In decision block 1004, if all later query segments have already been selected, then the component loops to block 1001 to select the next query segment, else the component continues to block 1005. In block 1005, the component employs a classifier to classify the last query in the selected query segment with the first query in the chosen query segment as representing the same or different query sessions. In decision block 1007, if the inclusion type of the selected query is consistent with the queries being in the same query segment, then the component continues at block 1008, else the component loops to block 1003 to choose the next later query segment. In block 1003, the component stitches the selected and chosen query segments together and then moves to block 1003 to select the next later query segment.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. For example, in some embodiments, the suggestion system may provide suggestions of feature for inclusion in a query without the user having to select a specific clause. As the user enters the partial query, the suggestion system may provide suggestions for only the clause that the user is currently enter or for all the clauses of the partial query. Accordingly, the invention is not limited except as by the appended claims.

I/We claim:

1. A method in computing device for providing suggestions of features for inclusion in a clause of a query, the query being a structured query with clauses, each clause having a feature, the method comprising:
providing a query log having queries submitted by one or more users;
receiving a partial query that is being created by a user;
analyzing the query log to identify features to suggest to the user based on a likelihood that users who submitted queries similar to the partial query included that feature in the query; and
presenting to the user the identified features as suggestions to include in the partial query.

2. The method of claim 1 wherein a query is similar to the partial query based on the number of features that are common to both the query and the partial query.

3. The method of claim 1 wherein the likelihood that users included a feature is based on a probability of similar queries including that feature in a selected clause of the partial query.

4. The method of claim 3 wherein the features with the highest probabilities are selected.

5. The method of claim 3 wherein the features with the highest probabilities and that will likely lead to distinct queries are selected.

6. The method of claim 1 wherein the analyzing includes
repeating until the number of identified features is greater than a desired number,
selecting popular features of similar queries, where a query is similar to the partial query when the query has a certain number of features in common with the partial query;
identifying as an identified feature each popular feature that has not already been identified and that is in the selected clause; and
decrementing the certain number.

7. The method of claim 1 including generating a query table, a feature table, and a query/feature table from the query log, the query table having fields including a query identifier and a query text for each query in the query log, the feature table having fields including a feature identifier, a feature description, and a clause type for each unique feature of the query log, the query/feature table having fields including a query identifier field and a feature identifier that map each query to the features of the query.

8. The method of claim 7 wherein the similar queries are identified by executing a query against the generated tables.

9. The method of claim 1 wherein the queries are based on a structured query language.

10. A computer-readable storage medium storing computer-executable instructions for controlling a computing system to suggest features for inclusion in a clause of a partial query, each query having clauses and features, the computer-executable instructions comprising:
a component that receives a partial query; and
a component that identifies features as suggestions to be included in the partial query based on an analysis of queries similar to the partial query that were submitted by one or more users.

11. The computer-readable storage medium of claim 10 including a component that presents to a user the identified features as suggestions to include in a selected clause of the partial query.

12. The computer-readable storage medium of claim 10 wherein a query is similar to the partial query based on the number of features that are common to both the query and the partial query.

13. The computer-readable storage medium of claim 10 wherein the analysis determines a probability of similar queries including that feature.

14. The computer-readable storage medium of claim 13 wherein the features with the highest probabilities are selected.

15. The computer-readable storage medium of claim 13 wherein the features with the highest probabilities and that will likely lead to distinct queries are selected.

16. A computer-readable storage medium storing computer-executable instructions for controlling a computing system to identify query sessions, by a method comprising:
providing a query log having queries submitted by a user and times of submission;
segmenting the queries into segments, where the queries of a segment are time-wise adjacent and within the same query session; and
stitching the segments into query sessions, where the segments of a query session are not time-wise adjacent but are within the same query session.

17. The computer-readable storage medium of claim 16 wherein the segmenting includes generating a feature set for a pair of queries and classifying the queries of the pair as either being in the same session or not using a supervised classification technique.

18. The computer-readable storage medium of claim 16 wherein the stitching includes generating a feature set for a pair of queries that includes the last query of a segment earlier in time and the first query of a segment later in time and classifying the queries of the pair as being in the same session or not using a supervised classification technique.

19. The computer-readable storage medium of claim 16 wherein separating and stitching generates features sets with features selected from the group consisting of time, cosine similarity between queries, and inclusion type.

20. The computer-readable storage medium of claim 19 wherein the inclusion type indicates whether the first query and the second query of a pair are the same, whether the first query of the pair has more or less terms than the second query of the pair, and whether the first query of the pair is a sub-query or a super-query of the second query of the pair.
